(19) United States
(12) Patent Application Publication
(10) Pub. No.: US 2004/0252075 A1
(43) Pub. Date: Dec. 16, 2004

(54) Information apparatus and display device switching method

(75) Inventor: Tadayuki Matsubara, Ome-shi (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/822,779

(22) Filed: Apr. 13, 2004

(30) Foreign Application Priority Data
Jun. 16, 2003 (JP) 2003-171218

(51) Int. Cl. G09G 5/00

(52) U.S. Cl. 345/1.1

(57) ABSTRACT

There is provided an information apparatus to which a first display device and a second display device are connectable. The information apparatus includes a built-in display device, a keyboard, a switch button, a first switching process unit configured to switch, each time a predetermined key operation is effected on the keyboard, a display destination to one of at least i) the built-in display device, ii) the first display device and iii) the second display device, and a second switching process unit configured to switch, when the first display device is disconnected, a display destination between the built-in display device and the second display device, each time the switch button is depressed.

### CROSS-REFERENCE TO RELATED APPLICATIONS

This application is based upon and claims the benefit of priority from prior Japanese Patent Application No. 2003-171218, filed Jun. 16, 2003, the entire contents of which are incorporated herein by reference.

### BACKGROUND OF THE INVENTION

1. Field of the Invention

The present invention relates to an information apparatus and a display device switching method, capable of performing a display device switching operation.

2. Description of the Related Art

In recent years, an information apparatus such as a personal computer (PC) has a variety of interface ports (connectors), for example, on a rear side of the main body thereof. These interface ports serve for cable-connection to display devices such as a cathode ray tube (CRT) and a TV monitor, in addition to a built-in liquid crystal display (LCD).

In this type of information apparatuses, there is known an apparatus that has a function for successively switching a display destination in accordance with a predetermined key operation on the keyboard. Specifically, each time a predetermined key operation (e.g. simultaneous depression of “Fn” key and “F5” key) is effected on the keyboard, a display destination is successively switched to one of i) LCD, ii) LCD and CRT, iii) CRT, iv) TV monitor and LCD, and v) TV monitor.

Thus, the user can select a desired mode of screen display.

When the user switches a display destination by the predetermined key operation on the keyboard, he/she has to select the desired display device(s) while viewing the screen of the built-in LCD. In this switching operation, if the designated screen display is the CRT or TV monitor, the screen of the built-in LCD displays no image (“blackout”). This makes it difficult for the user to understand, during the switching operation, which is the currently designated screen display, i) LCD, ii) LCD and CRT, iii) CRT, iv) TV monitor and LCD, or v) TV monitor. In particular, if the switching operation is performed in the state in which an external display device such as a TV monitor is not connected to the body of the information apparatus, it is very difficult to understand the currently designated screen display.

### BRIEF SUMMARY OF THE INVENTION

Embodiments of the present invention may provide an information apparatus and a display device switching method, capable of performing a display device switching operation with high user-friendliness.

According to one aspect of the present invention, there is provided an information apparatus to which a first display device and a second display device are connectable, comprising a built-in display device; a keyboard; a switch button; a first switching process unit configured to switch, each time a predetermined key operation is effected on the keyboard, a display destination to one of at least i) the built-in display device, ii) the first display device and iii) the second display device; and a second switching process unit configured to switch, when the first display device is disconnected, a display destination between the built-in display device and the second display device, each time the switch button is depressed.

According to another aspect of the present invention, there is provided a display device switching method applied to an information apparatus to which a first display device and a second display device are connectable and which includes a built-in display device, a keyboard, and a switch button, the method comprising executing a first switching process for switching, each time a predetermined key operation is effected on the keyboard, a display destination to one of at least i) the built-in display device, ii) the first display device and iii) the second display device; and executing a second switching process for switching, when the first display device is disconnected, a display destination between the built-in display device and the second display device, each time the switch button is depressed.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an external appearance of an information apparatus according to an embodiment of the present invention;

FIG. 2 is a block diagram showing an example of the internal structure of the information apparatus;

FIG. 3 is a block diagram showing the functional configuration of a display switching process application which is executed by a CPU;

FIG. 4 illustrates the procedure of a switching process (first switching process) to be executed by a first switching process unit;

FIG. 5 illustrates the procedure of a switching process (second switching process) to be executed by a second switching process unit;

FIG. 6 shows a setting screen through which a user changes settings of button functions; and

FIG. 7 is a flow chart illustrating the operation by the display switching process application.

### DETAILED DESCRIPTION OF THE INVENTION

Embodiments of the present invention will be described below with reference to the drawings.

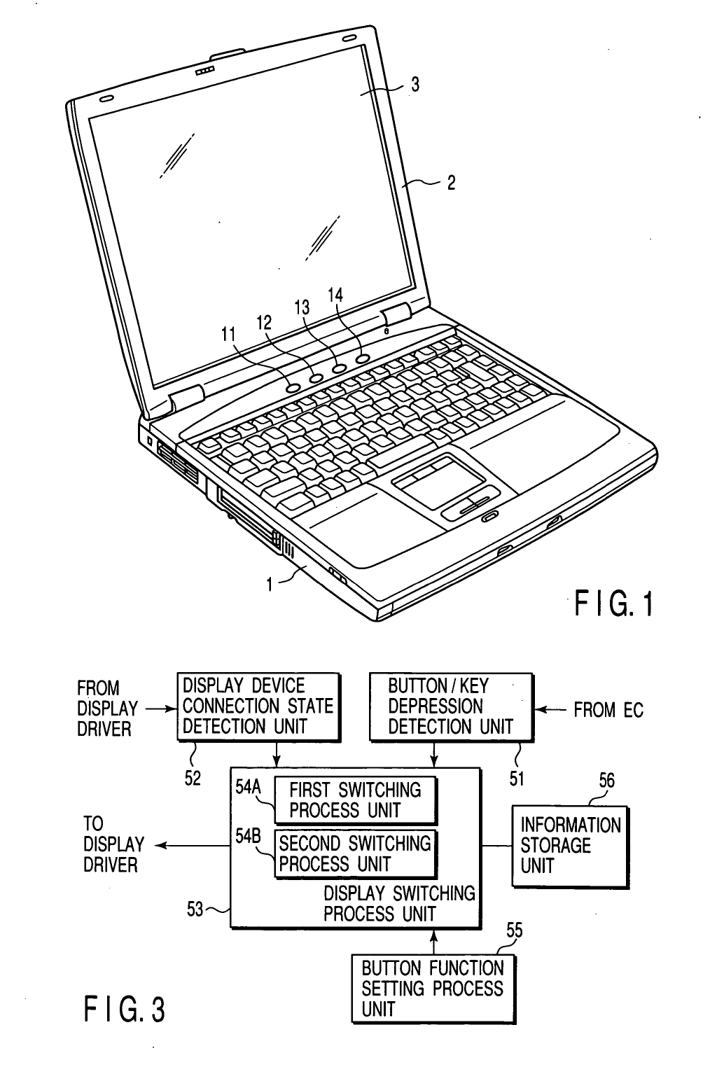

FIG. 1 is a perspective view showing an external appearance of an information apparatus according to an embodiment of the present invention.

The information apparatus is, for instance, a personal computer (PC). The information apparatus includes a main body 1 and a display unit 2. The display unit 2 incorporates an LCD device 3 (hereinafter referred to simply as “LCD” in some places) as a built-in display device. The display unit 2 is attached to the main body 1 so as to be rotatable between an open position and a closed position.

The main body 1 has a thin box-shaped casing. A keyboard with a plurality of keys is disposed on an upper surface of the casing. In addition, a power button 11, an Internet button 12, a mail button 13 and a switch button 14 are provided on the casing. A process associated with each of these buttons is executed each time it is depressed.

The power button 11 is a button, for example, for turning on power to the main body.

The Internet button 12 is a button for activating a designated browser.

The main button 13 is a button for activating a designated mailer (mail software).

The switch button 14 is a button used for switching a display destination (i.e., selecting a display device to be used to display data) and the like.

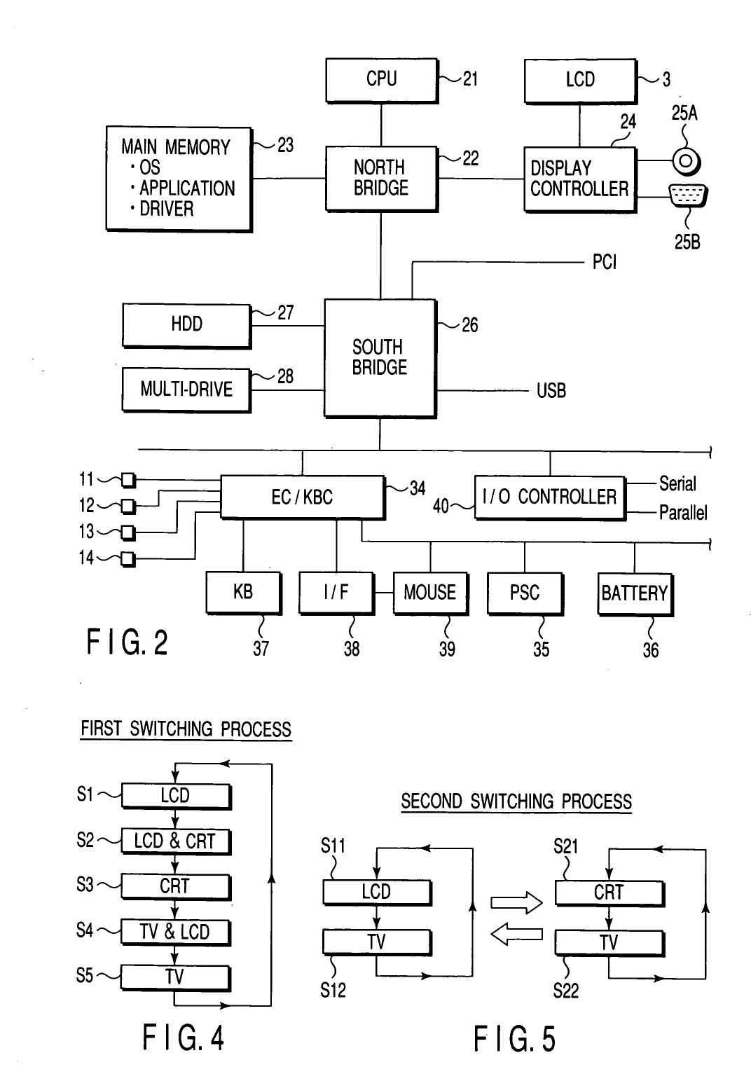

FIG. 2 is a block diagram showing an example of the internal structure of the information apparatus.

The information apparatus includes, as well as the aforementioned LCD 3, power button 11, Internet button 12, mail button 13 and switch button 14, a central processing unit (CPU) 21, a north bridge 22, a main memory 23, a display controller 24, a display section 25, a south bridge 26, a hard disk drive (HDD) 27, multi-drive 28, an embedded controller/keyboard controller (EC/KBC) 34, a power supply controller (PSC) 35, a battery 36, a keyboard (KB) 37, a mouse interface (I/F) 38, a mouse 39, and an I/O controller 40.

The CPU 21 controls the entirety of the PC. The CPU 21 uses the main memory 23 as a working area and executes processes relating to, e.g. an operating system (OS), various applications and various drivers. The applications include a display switching process application (to be described later). The drivers include a display driver for controlling a TV monitor device that is an external monitor for connection to a video output terminal 25A (hereinafter referred simply as “TV monitor”) and a display driver for controlling a CRT device that is an external monitor for connection to a CRT output terminal 25B (hereinafter referred simply as “CRT”).

The north bridge 22 includes various controllers for executing, for instance, a bridge process between the CPU 21 and south bridge 26, a control for the main memory 23 and a control for the display controller 24.

The main memory 23 stores the OS, various applications and various drivers, which are executed by the CPU 21. The main memory 23 is provided as a working area for the CPU 21.

The display controller 24 is connected to the north bridge 22 via an accelerated graphics port (AGP). In accordance with instructions from the CPU 21 that executes the display switching process application, the display controller 24 effects screen display on the LCD 3, screen display on the TV monitor that is connected to the video output terminal 25A, and screen display on the CRT that is connected to the CRT output terminal 25B.

The south bridge 26 is connected to the north bridge 22 via a hub link. The south bridge 26 includes various controllers for controlling, e.g. various devices (EC/KBC 34, I/O controller, etc.) on a low pin count (LPC) bus, various PCI (Peripheral Component Interconnect) devices on a PCI bus, a disk drive that is supported by integrated drive electronics (IDE) interface, and a universal serial bus (USB) device.

The HDD 27 is connected to the south bridge 26 as a device corresponding to a primary IDE. The HDD 27 drives a built-in hard disk that stores the OS and various programs.

The multi-drive 28 is connected to the south bridge 26 as a device corresponding to a secondary IDE. The multi-drive 28 drives a CD-ROM, a DVD-ROM and a CD-R/RW, which are removable storage media.

The EC/KBC 34 is connected to the LPC bus. The EC/KBC 34 detects depression of the power button 11, Internet button 12, main button 13 and switch button 14, and controls the power supply controller 35 and an input device such as a keyboard 37. The EC/KBC 34 is an integrated unit of an EC that is a built-in controller, and a keyboard controller. In particular, when the buttons 11 to 14 and the keys on the keyboard 37 are depressed, the EC detects depression of each button or key and informs the CPU 21 of the associated operational content.

The power supply controller 35 is connected to the EC/KBC 34 via an I²C bus, and controls voltage that is supplied to the respective parts in the PC.

The battery 36 is used as a power supply to the respective parts in the PC in a case where external power is not supplied, for example, while the PC is being moved.

The keyboard 37 is connected to the EC/KBC 34 and delivers input signals corresponding to depression of various keys to the KBC.

The mouse interface 38 functions as an interface between the mouse 29 and EC/KBC 34.

The mouse 39 is connected to the mouse interface 38 and performs input operations by, e.g. clicking.

The I/O controller 40 is connected to the LPC bus and executes an input/output control of serial signals and parallel signals with the outside.

FIG. 3 is a block diagram showing the functional configuration of the display switching process application which is executed by the CPU 21.

A button/key depression detection unit 51 receives predetermined information from the EC and detects individual depression of a specific switch button 14 and depression of keys on the keyboard 37 (e.g. depression of “Fn” key and “F5” key).

A display device connection state detection unit 52 receives predetermined information from the display driver and detects the connection state (connection/disconnection) of the TV monitor that is connected to the video output terminal 25A and the CRT that is connected to the CRT output terminal 25B.

A display switch process unit 53 functions to instruct the display driver to switch the screen display of the associated display device, on the basis of the detection results of the button/key depression detection unit 51 and display device connection state detection unit 52. The display switch process unit 53 includes a first switch process unit 54A and a second switch process unit 54B.

The first switch process unit 54A executes a process of switching a display destination in the order of i) LCD 3, ii) LCD 3 and CRT, iii) CRT, iv) TV monitor and LCD 3 and v) TV monitor, each time the “Fn” key and “F5” key are depressed on the keyboard 37.

When the CRT monitor is disconnected, the second switch process unit 54B alternately switches a display destination between the LCD 3 and TV monitor, each time the switch button 14 is depressed. When the CRT monitor is connected, the second switch process unit 54B alternately switches a display destination between the CRT and TV monitor, each time the switch button 14 is depressed.

A button function setting process unit 55 functions to change the setting of the switch process content of the second switch process unit 54B in accordance with the input operation by the user on a predetermined setting screen. For example, the setting can be changed such that each time the switch button 14 is depressed, the execution of a predetermined application software (word processor, music player, etc.) and the screen display on the LCD are alternately switched.

The information storage unit 56 stores, e.g. the content that is set by the button function setting process unit 55, and the state of the screen of the display device that is switched by the display switching process unit 53.

FIG. 4 shows the procedure of the switching process (first switching process) that is executed by the first switching process unit 54A.

In the first switching process unit 54A, as shown in FIG. 4, each time the “Fn” key and “F5 key” are depressed on the keyboard 37, a display destination is successively switched in the following order: “LCD” (step S1), “LCD & CRT” (step S2), “CRT” (step S3), “TV monitor & LCD” (step S4), “TV monitor” (step 5), “LCD” (step S1), . . .

FIG. 5 shows the procedure of the switching process (second switching process) that is executed by the second switching process unit 54B.

In the second switching process unit 54B, when the CRT monitor is disconnected, a display destination is alternately switched between “LCD” (step S11) and “TV monitor” (step S12), each time the switch button 14 is depressed.

On the other hand, when the CRT monitor is connected, a display destination is alternately switched between “CRT” (step S21) and “TV monitor” (step S22), each time the switch button 14 is depressed.

The operation of steps S11 and S12 and the operation of steps S21 and S22 are dynamically changed according to the connection state of the CRT monitor.

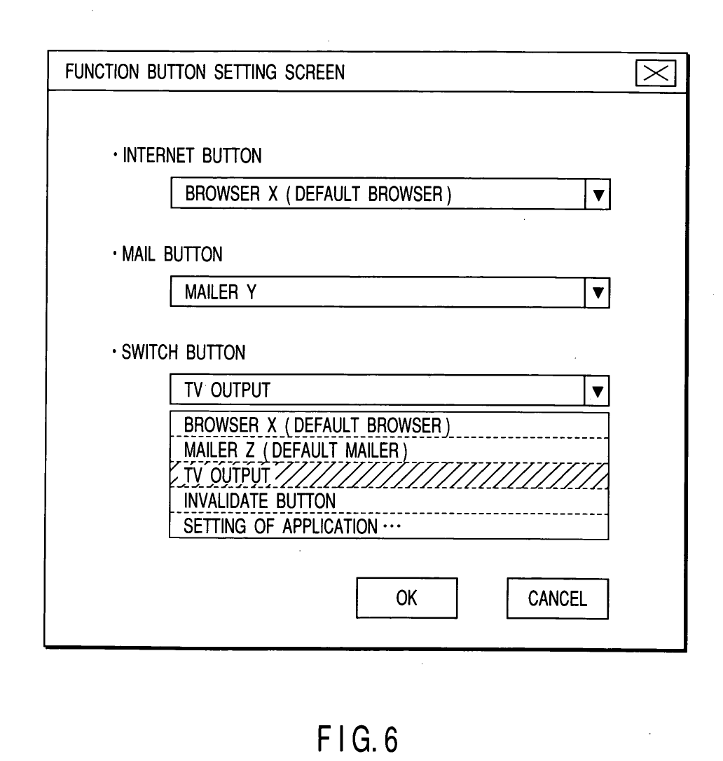

FIG. 6 shows a setting screen for enabling the user to change the settings of the button functions.

As shown in FIG. 6, the items of various buttons, such as “INTERNET BUTTON”, “MAIL BUTTON” and “SWITCH BUTTON”, are provided on the setting screen.

The item “INTERNET BUTTON” is provided to designate the browser that is to be activated when the Internet button 12 is depressed.

The item “MAIL BUTTON” is provided to designate the mailer that is to be activated when the mail button is depressed.

The item “SWITCH BUTTON” is provided to designate the details of the switching between the “execution of desired process (browser, mailer, TV output, invalidation of the switch button, predetermined application)” and the “screen display on LCD”, each time the switch button 14 is depressed. If the “TV output” is designated as the desired process, the switching between the “TV monitor” and “LCD” (or “CRT”) is set to be executed.

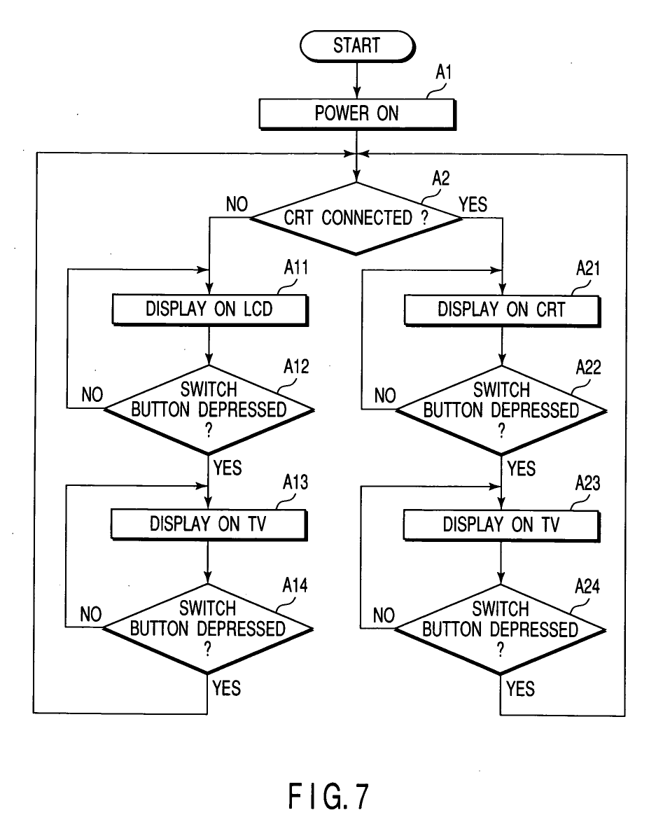

Referring to a flow chart of FIG. 7, the operation of the display switching process application will now be described.

If the power button 11 of the information apparatus is depressed (step A1), the main body is activated and it is determined whether the CRT is connected to the main body of the information apparatus (step A2).

If it is determined that the CRT is not connected to the main body, the LCD, which is one of a plurality of display devices, is used for screen display (step A11). Then, if the switch button 14 is depressed (step A12), the screen display on the LCD is switched to the screen display on the TV monitor (step A13). Thereafter, if the switch button 14 is depressed (step A14), the screen display on the TV monitor (step A13) is switched to the screen display on the LCD (step A11) or to the screen display on the CRT (step A21).

On the other hand, if it is determined in step A2 that the CRT is connected to the main body, the CRT, which is one of a plurality of display devices, is used for screen display (step A21). Then, if the switch button 14 is depressed (step A22), the screen display on the CRT is switched to the screen display on the TV monitor (step A23). Thereafter, if the switch button 14 is depressed (step A24), the process from step A2 is repeated. In this case, the screen display on the TV monitor (step A23) is switched to the screen display on the LCD (step A11) or to the screen display on the CRT (step A21).

As has been described above, according to the present embodiment, the user can perform the screen switching operation by means of the specific switch button 14, in addition to the screen switching operation by means of the combination of the “Fn” key and “F5” key. Thus, the desired operation method can freely be chosen, and the user-friendliness is enhanced. Besides, if the switch button 14 is used, the user can immediately understand the individual screen display mode, even when the switching operation is performed in the state in which the external display device such as the TV monitor is not connected to the main body of the information apparatus.

According to the present invention, the display device switching operation with high user-friendliness can be realized.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information apparatus to which a first display device and a second display device are connectable, comprising:
a built-in display device;
a keyboard;
a switch button;
a first switching process unit configured to switch, each time a predetermined key operation is effected on the keyboard, a display destination to one of at least i) the built-in display device, ii) the first display device and iii) the second display device; and
a second switching process unit configured to switch, when the first display device is disconnected, a display destination between the built-in display device and the second display device, each time the switch button is depressed.

2. The information apparatus according to claim 1, wherein the second switching process unit switches, when the first display device is connected, a display destination between the first display device and the second display device, each time the switch button is depressed.

3. The information apparatus according to claim 1, further comprising a setting process unit configured to change setting of a switching process of the second switching process unit to switch i) execution of a predetermined application and ii) screen display on the built-in display device, each time the switch button is depressed.

4. The information apparatus according to claim 1, wherein the first display device is a CRT device.

5. The information apparatus according to claim 1, wherein the second display device is a TV monitor device.

6. The information apparatus according to claim 1, wherein the built-in display device is an LCD device.

7. An information apparatus to which a CRT device and a TV monitor device are connectable, comprising:
a built-in LCD device;
a keyboard;
a switch button;
a first switching process unit configured to switch, each time a predetermined key operation is effected on the keyboard, a display destination to one of i) the LCD device, ii) the LCD device and the CRT device, iii) the CRT device, iv) the TV monitor device and the LCD device and v) the TV monitor device; and
a second switching process unit configured to switch, when the CRT device is disconnected, a display destination between the LCD device and the TV monitor device, each time the switch button is depressed, and to switch, when the CRT device is connected, a display destination between the CRT device and the TV monitor device, each time the switch button is depressed.

8. The information apparatus according to claim 7, further comprising a setting process unit configured to change setting of a switching process of the second switching process unit to switch i) execution of a predetermined application and ii) screen display on the LCD device, each time the switch button is depressed.

9. A display device switching method applied to an information apparatus to which a first display device and a second display device are connectable and which includes a built-in display device, a keyboard, and a switch button, the method comprising:
executing a first switching process for switching, each time a predetermined key operation is effected on the keyboard, a display destination to one of at least i) the built-in display device, ii) the first display device and iii) the second display device; and
executing a second switching process for switching, when the first display device is disconnected, a display destination between the built-in display device and the second display device, each time the switch button is depressed.

10. The display device switching method according to claim 9, wherein the second switching process switches, when the first display device is connected, a display destination between the first display device and the second display device, each time the switch button is depressed.

11. The display device switching method according to claim 9, further comprising:
causing to change setting of the second switching process to switch i) execution of a predetermined application and ii) screen display on the built-in display device, each time the switch button is depressed.
